(19) United States
(12) Patent Application Publication
(10) Pub. No.: US 2017/0352266 A1
(43) Pub. Date: Dec. 7, 2017

(54) ADVANCED FLOOD GAUGE

(71) Applicant: KYLE LYNN WATSON, PINEHURST, TX (US)

(72) Inventor: KYLE LYNN WATSON, PINEHURST, TX (US)

(21) Appl. No.: 15/474,873

(22) Filed: Mar. 30, 2017

Related U.S. Application Data
(60) Provisional application No. 62/344,824, filed on Jun. 2, 2016.

(51) Int. Cl. G08G 1/095; G08B 5/36; G01F 23/00

(52) U.S. Cl. CPC G08G 1/095; G01F 23/0007; G08B 5/36

(57) ABSTRACT

An alert system is disclosed providing motorists an alert in advance of flood areas being flooded. The disclosed system provides real-time information on water levels adjacent or on top of roadways. As water levels enter a gauge unit, a signal from the gauge unit is sent to trigger a warning light that motorists or pedestrians can see from the roadway before reaching an area of the roadway that maybe flooded. The embodiments disclosed may prevent loss of life and avoid costly automotive repairs due to water damage.

### CROSS-REFERENCE TO RELATED APPLICATIONS

This application claims priority to provisional patent application U.S. Ser. No. 62/344,824 filed on Jun. 2, 2016, the entire contents of which, including drawings and specification are herein incorporated by reference.

### BACKGROUND

The embodiments described herein relate generally to warning systems, and more particularly, to an advanced flood gauge system.

Roadways are often flooded over without warning. Motorists and pedestrians have no idea whether the current water level of an area prone to flooding is dangerous until they attempt to cross the roadway. Often, a motorist will try to visually gauge the water depth as they cross a road which maybe too late.

Currently, flood warning systems use a static sign that includes a gradient to measure water depth. The sign must be read by physically approaching the body of water and manually reading the sign. This presents danger to the person reading the sign as the area may already be too dangerous to enter when flood waters are present. It is common for a government employee to post a road closure only until after someone has been caught in flooded waters. Once a motorist gets caught in a flooded area, they have to be rescued by fast running water rescue squads or by airlift. Both are expensive. Even when the person is rescued, the automobile becomes overwhelmed with water which causes expensive water damage to repair.

Therefore, what is needed is a warning system in advance of approaching a potentially flooded area to alert people of the potential for or current flooding of an area without a person having to manually evaluate flood conditions.

### SUMMARY

In one aspect of the subject disclosure, a flood gauge system for warning people of flooded areas prior to contact comprises a gauge unit positioned in a waterway. The gauge unit includes one or more sensors in a housing measuring a water level as water enters or exits a housing. A signal is transmitted from the gauge unit in response to a pre-defined water level(s) being reached. A control unit may be configured to receive the signal transmission and determine whether a current condition of the waterway is safe, requires caution, or is flooded based on the received signal transmission from the gauge unit. A warning light unit may be positioned remotely from the gauge unit and in a path proximate a roadway ahead of where the roadway crosses over the waterway. The warning light unit includes a light illuminated in response to the gauge unit measuring a current water level as flooding the roadway.

In another aspect, a flood gauge system for advance warning of a flooded area comprises a gauge unit positioned in or proximate a waterway. The gauge unit includes one or more float based sensors in a housing measuring a water level as water enters or exits a housing. A rail is included in the gauge unit housing so that the one or more float based sensors are adjustable in height along the rail. A signal is transmitted from the gauge unit in response to a pre-defined water level(s) being reached. A control unit is configured to receive the signal transmission. The control unit is configured to determine whether a current condition of the waterway is safe, requires caution, or is flooded based on the received signal transmission from the gauge unit. A warning light unit may be positioned remotely from the gauge unit and in a path proximate a roadway ahead of where the roadway crosses over the waterway. The warning light unit includes three lights representing different stages of water levels and are illuminated in response to the gauge unit measuring a current water level relative to flooding of the roadway.

### BRIEF DESCRIPTION OF THE FIGURES

The detailed description of some embodiments of the invention is made below with reference to the accompanying figures, wherein like numerals represent corresponding parts of the figures.

FIG. 1 is a side, elevation view of an advanced flood gauge system according to an embodiment of the subject technology.

FIG. 2 is a front, elevation view of a remote gauge unit in the system of FIG. 1.

FIG. 3 is a cross-sectional view taken along the line 2-2 of FIG. 2.

FIG. 4 is a side, elevation view of a control unit in the system of FIG. 1.

FIG. 5 is a front, elevation view of the control unit of FIG. 4 with door open.

FIG. 6 is a front, elevation view of a remote light unit in the system of FIG. 1.

FIG. 7 is a cross-sectional view taken along 6-6 of FIG. 6.

FIG. 8 is a logic ladder schematic for lighting warning lights in the system according to an embodiment of the subject technology.

### DETAILED DESCRIPTION OF CERTAIN EMBODIMENTS

In general, embodiments of the disclosed invention provide an alert system providing motorists an alert in advance of flood areas being flooded with rising water. As will be appreciated, aspects of the disclosed system provide real-time information on water levels adjacent or on top of roadways. The embodiments disclosed may prevent loss of life and avoid costly automotive repairs due to water damage.

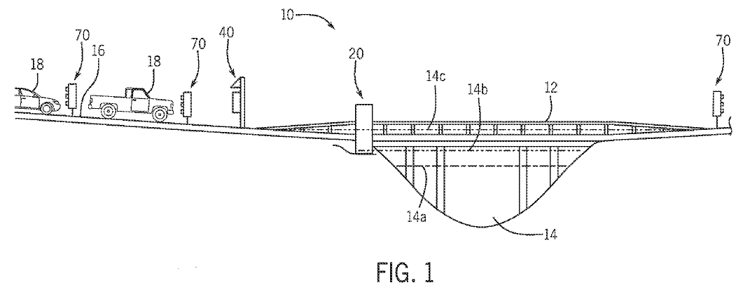

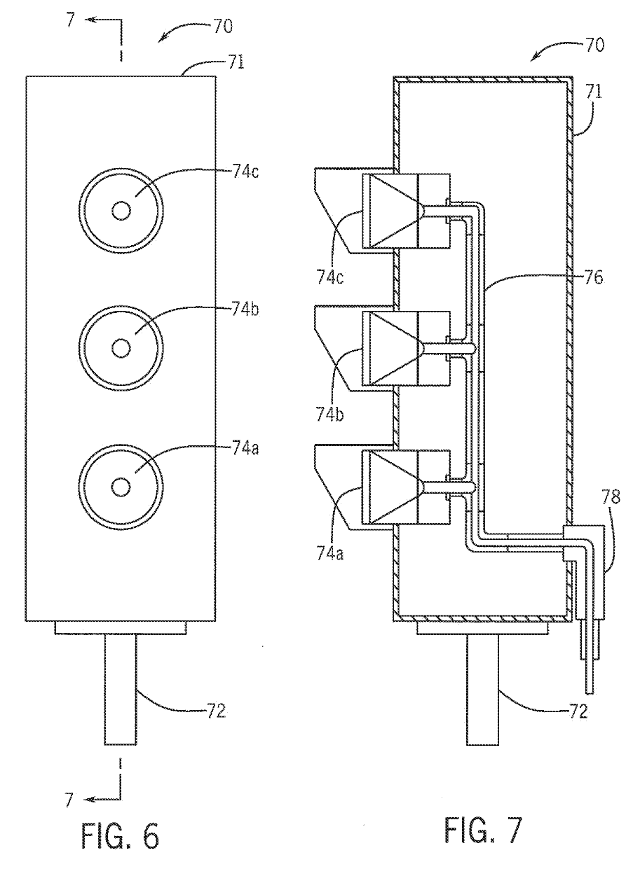

Referring now to FIG. 1, a flood gauge system 10 (referred to generally as the “system 10”) is shown according to an exemplary embodiment. The system 10 generally includes a remote gauge unit 20 in communication with a control unit 40 and one or more light warning units 70. For sake of illustration, wiring between the gauge unit 20, control unit 40 and warning light units 70 is not shown however it will be understood that any wiring between elements may be buried beneath ground. However some embodiments may include the use of wireless transmitters/receivers between units for communication without departing from the scope of the invention. In operation, the system 10 and its elements are positioned adjacent a water way that is proximate a roadway or pedestrian path. In some embodiments, the system 10 may be positioned near roadways that are not necessarily next to a body of water but are subject to flash flooding when heavy rains come down. The gauge unit 20 is positioned proximate the water (or near terrain that feeds flooding into the roadway) and is disposed to measure the water level during times of heavy rain/increasing water flow. For example, the gauge unit 20 may be positioned along the banks of a river 14 near a bridge 12 that includes a roadway 16 for vehicles 18. The warning light units 70 may be positioned in advance of one or both ends of the bridge 12. In an exemplary embodiment, the control unit 40 is positioned in proximity to the gauge unit 20 and warning lights 70 but in some embodiments, may be positioned distantly from the river 14 to avoid being overtaken by flood waters. As the water level of the river 14 increases/decreases, the gauge unit 20 measures the level and sends a signal to the control unit 40 indicating the current water level. The control unit 40 responds to the signal by issuing a signal to the warning light units 70 commanding the units 70 to illuminate a warning level dependent on the current water level. Details of the warning light units 70 are described below in FIGS. 6 and 7. In addition, the control unit 40 may issue commands to other elements connected to the system 10 such as gates, drawbridges, etc. to open/close depending on the water level.

Still referring to FIG. 1, the water level 14a represents a safe water level that is below the surface of roadway 16. Water level 14b represents an elevated water level as a result of increasing water flow, rain, etc. Water level 14b remains below the surface of roadway 16 but is dangerously close to flooding the roadway 16 and merits a caution level warning. In some cases, water level 14b may be at the roadway 16 level (for example, due to direct contact by rain) but is not high enough to flood the roadway 16. The water level 14c represents a water level that has risen substantially above the roadway 16 and the roadway 16 is considered flooded and unsafe to pass through. Thus water level 14c will trigger an indication that the roadway 16 ahead is flooded and should not be entered.

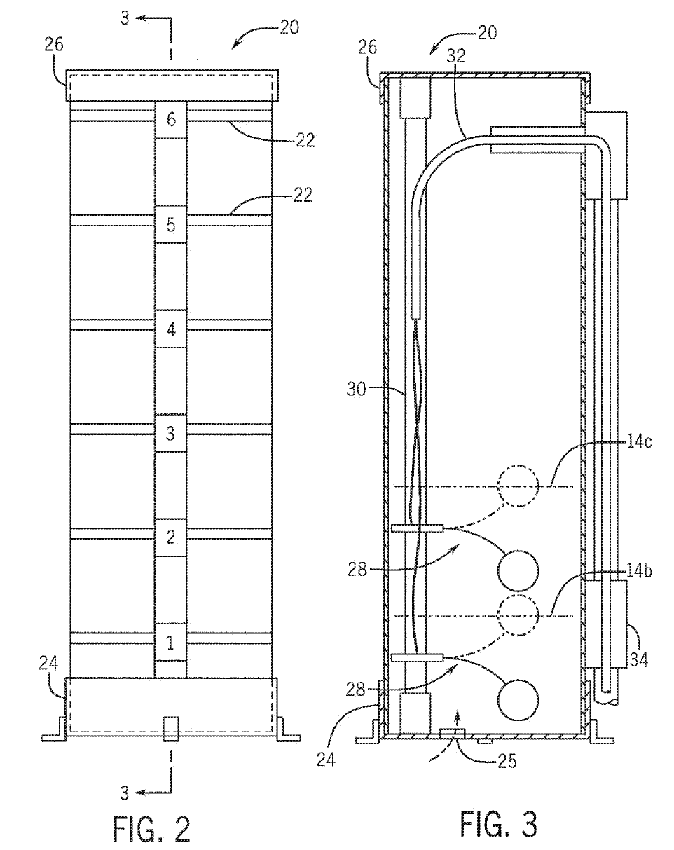

Referring now to FIGS. 2 and 3 concurrently with FIG. 1, the gauge unit 20 is shown according to an exemplary embodiment and will be described with respect to the monitoring of the water levels 14a, 14b, and 14c. Generally the gauge unit 20 is installed at the lowest elevation point in flood areas. The gauge unit 20 includes a housing secured at a water inlet base 24 to the ground adjacent or in the path of the river 14 (or other terrain through which water flows). In an exemplary embodiment, an inlet port 25 is positioned at the bottom of the inlet base 24 for ingress of water as the level rises. However it will be understood that alternate embodiments may position the inlet port 25 on the sides of the housing without departing from the scope of the invention or its functionality. The exterior of the housing may include a reflective water level scale 22 which provides a visible measurement of the current water level inside the housing. The housing may be capped off by a lid 26 to protect the interior components from damage. The gauge unit 20 may be set at the lowest elevation point of the roadway 16 (for example, starting at zero inches from the road surface). The lowest elevation and location of placement may be determined by the customer. For example, the gauge unit 20 location could be the shoulder of the roadway 16, the crown in the roadway 16 or even a sidewalk next to the roadway 16.

The housing interior may include a plurality of float sensor switches 28 to measure water depth as water enters through the inlet port 25. The float sensor switches 28 may be coupled to a supporting column rail 30 and may be adjustable in height along the rail 30, set in positions of water level height according to a customer's request. By this feature the pre-defined stages of water level warnings are programmable for applicability to the height relationship between the roadway 16 and waterway 14 (river). In an exemplary embodiment, the float sensor switches 28 include a float attached by a flexible tether to a ring or other fastener coupling the float to the rail 30. The ring may be connected to an electrical switch on the interior of the rail 30 which triggers a signal sent up along a power and control cable 32 within the rail 30 to a junction box 34 when the float raises the tether above a default height. The power and control cable 32 may be routed outside the housing to the control unit 40 as discussed above. In the very least, the signal from the power and control cable 32 is transmitted to the control unit 40 and/or warning light unit(s) 70. For example, the tether may be a metal strip that is by default flexed downward by gravity and once the float rises and raises the metal tether up beyond a flat level, a contact within the ring is made triggering the aforementioned signal. FIG. 3 shows a bottommost float sensor switch 28 having been raised high enough to indicate that the water level 14b has been reached and is at warning levels. In addition, the next float sensor switch 28 up has been risen above the triggering point for the flooded water level 14c generating the flooded signal.

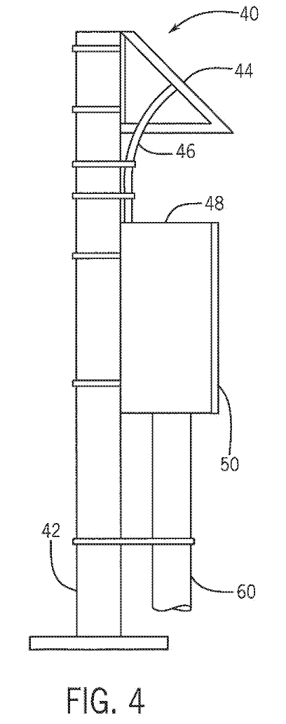

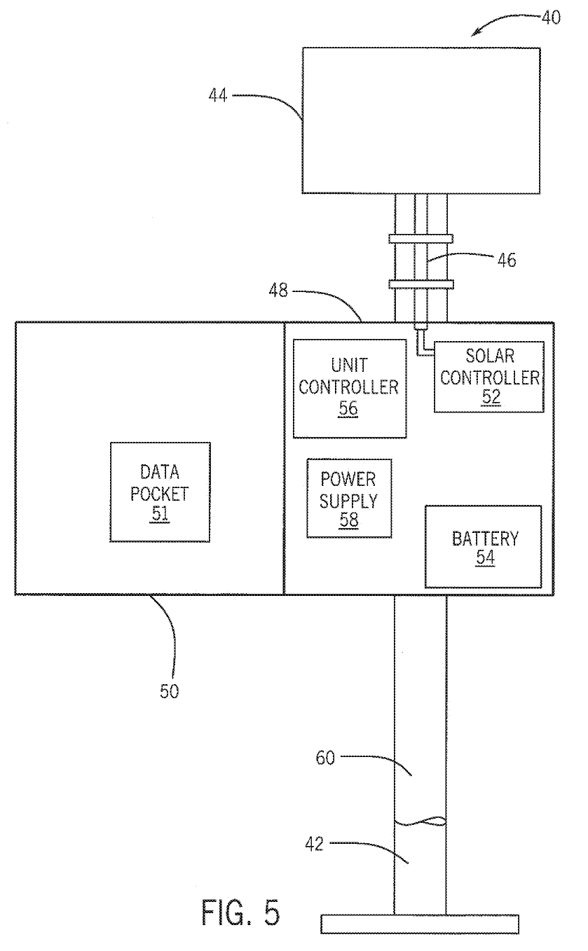

Referring now to FIGS. 4 and 5 concurrently with FIG. 1, a control unit 40 is shown according to an exemplary embodiment. The control unit 40 may be installed at a higher elevation in the area proximate the gauge unit 20. The control unit 40 may be mounted on a support stand 42 giving the unit 40 the ability to be moved up or down in height to stay out of flood waters. The control unit 40 may include a power supply 58 powered by an incoming power source through conduit 60 provided by the customer either underground or above ground. Some embodiments may include a solar panel 44 to provide power through wiring 46 which is managed by solar controller 52. Some embodiments include a battery 54 as a back-up power options in the event hardwired power is down and solar is unavailable. Control unit 40 controller elements may be housed in an enclosure 48 which are accessible via a door 50. Inside the enclosure 48 is a controller 56 that has two functions; one is to take the information from the gauge unit 20 and the other is to control the lights at the warning light unit(s) 70. In response to the signal from the gauge unit 20, the controller 56 sends a signal to the warning light unit(s) 70 to turn on/off lights representing the different water level stages.

FIGS. 6 and 7 show an exemplary embodiment of the warning light unit 70. The warning light unit 70 provides a motorist or pedestrian a clear visible signal of the current flood level information. A housing 71 may be supported on a stand 72. The housing 71 may include a plurality of warning lights 74. In an exemplary embodiment, three lights 74a, 74b, and 74c are shown which when illuminated represent the water levels 14a, 14b, and 14c respectively (safe, caution, and flooded). In some embodiments, the warning light unit 70 is hard wired to the control unit 40 (FIG. 4) and receives the signal from the control unit 40 through wire track 76 fed into the housing through junction box 78. The lights 74 may be colored providing a visual cue of the current flood level. For example, (and referring back to FIG. 3 in conjunction with FIG. 7) when the lowest float sensor switch 28 remains un-triggered, the signal sent to the warning light unit 70 may illuminate light 74a, which may be green to indicate the roadway 16 (FIG. 1) ahead is safe to traverse. In response to the lowest float sensor switch 28 being triggered, the light 74b (which may be yellow) may be illuminated to indicate the water level is currently high and in danger of flooding the roadway 16 ahead so caution should be used in proceeding through. Generally, as one warning light 74 is illuminated, the previously illuminated warning light is turned off. In response to the uppermost float sensor switch 28 being triggered, the warning light 74c (which may be red) may be illuminated to indicate the roadway 16 ahead is flooded and should not be traversed.

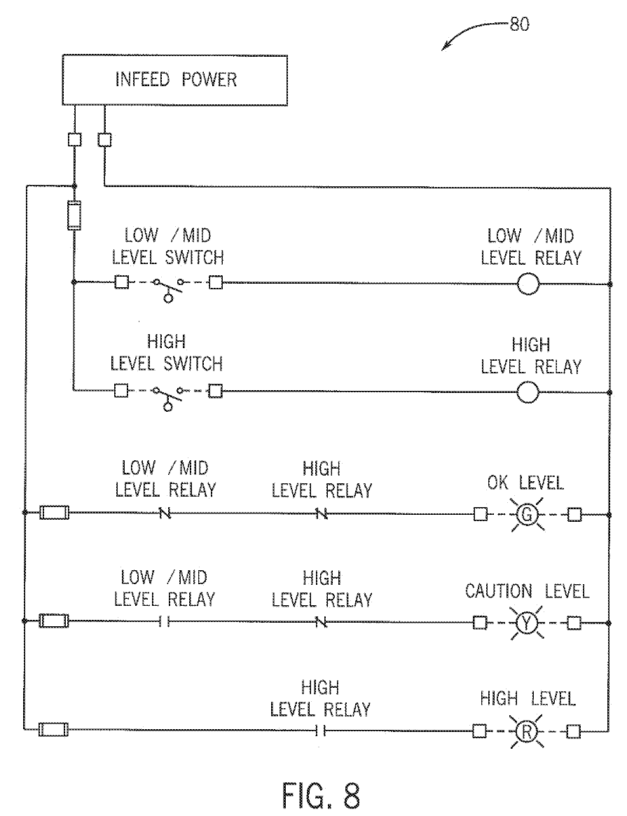

FIG. 8 shows an electrical logic schematic 80 for lighting the warning lights 74 described above. A set of relays may be opened or closed to illuminate (or turn off) lights 74a, 7b, or 74c depending on the conditions provided by the signals described.

Persons of ordinary skill in the art may appreciate that numerous design configurations may be possible to enjoy the functional benefits of the inventive systems. For example, while the gauge unit was described in the context of using a plurality of float sensor switches, other embodiments may use a single sensor that is configured to rise with the water level and trigger based on the water height measured. In addition, other embodiments may use a different kind of sensor than a tethered float while still achieving the same effectiveness of the disclosed system. Also while colored lights were used as an example, other visual cues may be used including text based warnings, audible warnings, and mechanical warnings such as a gate that is closed in response to the flooded condition being met. Thus, given the wide variety of configurations and arrangements of embodiments of the present invention the scope of the invention is reflected by the breadth of the claims below rather than narrowed by the embodiments described above.

1. An on-site flood gauge system for advance warning of a flooded area, comprising:
a gauge unit positioned in a waterway, the gauge unit including,
one or more sensors in a housing measuring a water level as water enters or exits the housing, and
a signal transmission from the gauge unit in response to a pre-defined water level(s) being reached,
a control unit hardwired to the gauge unit and configured to receive the signal transmission, the control unit positioned adjacent the waterway and configured to determine whether a current condition of the waterway is safe, requires caution, or is flooded based on the received signal transmission from the gauge unit; and
a warning light unit hardwired to the control unit and positioned remotely from the gauge unit and adjacent the waterway in a path proximate a roadway ahead of the waterway, wherein the roadway crosses over the waterway, the warning light unit including a light indicative of the current condition of the waterway and illuminated in response to the gauge unit measuring a current water level as flooding the roadway.

2. The system of claim 1, wherein the one or more sensors are float based sensors.

3. The system of claim 1, further comprising a rail in the gauge unit wherein the one or more sensors are adjustable in height along the rail.

4. The system of claim 3, wherein the pre-defined water level(s) are programmable by adjusting a position of the one or more sensors along the rail.

5. The system of claim 1, further comprising a solar panel powering the control unit.

6. The system of claim 1, further comprising two more warning lights indicating a safe water level and a caution stage water level in response to the received signal transmission from the gauge unit.

7. A flood gauge system for advance warning of a flooded area, comprising:
a gauge unit positioned in or proximate a waterway, the gauge unit including,
one or more float based sensors in a housing measuring a water level as water enters or exits the housing,
a rail in the gauge unit housing wherein the one or more float based sensors are adjustable in height along the rail, and
a signal transmission from the gauge unit in response to a pre-defined water level(s) being reached,
a control unit hardwired to the gauge unit and configured to receive the signal transmission, the control unit positioned adjacent the waterway and configured to determine whether a current condition of the waterway is safe, requires caution, or is flooded based on the received signal transmission from the gauge unit; and
a warning light unit positioned remotely from the gauge unit and adjacent the waterway in a path proximate a roadway ahead of the waterway, wherein the roadway crosses over the waterway, the warning light unit including three lights representing different stages of water levels and illuminated in response to the gauge unit measuring a current water level in the waterway relative to flooding of the roadway.
